(19) United States
(12) Patent Application Publication
(10) Pub. No.: US 2021/0230023 A1
(43) Pub. Date: Jul. 29, 2021

(54) SUBMERGED TUBULAR MEMBRANE DISTILLATION (STMD) METHOD AND APPARATUS FOR DESALINATION

(71) Applicants: THANH XUAN BUI, HO CHI MINH (VN); MY THI TRA NGO, HO CHI MINH (VN); NGUYEN CONG NGUYEN, LAM DONG (VN)

(72) Inventors: THANH XUAN BUI, HO CHI MINH (VN); MY THI TRA NGO, HO CHI MINH (VN); NGUYEN CONG NGUYEN, LAM DONG (VN)

(73) Assignees: VIETNAM NATIONAL UNIVERSITY HO CHI MINH CITY, HO CHI MINH (VN); HO CHI MINH CITY UNIVERSITY OF TECHNOLOGY, HO CHI MINH (VN)

(21) Appl. No.: 16/752,624

(22) Filed: Jan. 25, 2020

(51) Int. Cl. C02F 1/44; B01D 61/36; B01D 63/06; B01D 69/02; B01D 71/36

(52) U.S. Cl. CPC C02F 1/447; B01D 61/364; B01D 61/366; C02F 2103/08; B01D 63/065; B01D 69/02; B01D 71/36; B01D 61/368

(57) ABSTRACT

A desalination apparatus is disclosed which comprises: a first tank for storing seawater to be desalinated; a second tank comprising a hydrophobic membrane desalination module operable to absorb only fresh water vapors and reject salt components when the seawater is heated to a first predetermined temperature that changes the seawater into the fresh water vapors, and wherein the hydrophobic membrane desalination module is configured to continuously allow the distilled fresh water to make contact with the fresh water vapors within its interior hollow volume; and a third tank, in fluid communication with the second tank, configured to cause the fresh water vapors from the hydrophobic membrane desalination module to be condensed into liquid fresh water by continuously allowing the fresh water vapors to make contact with a coolant water at a second temperature.

### FIELD OF THE INVENTION

The present disclosure generally relates to a desalination apparatus. More particularly, the present disclosure relates to a submerged tubular membrane desalination membrane (STMD) apparatus for desalination for producing fresh water from seawater, brines, brackish water and the likes.

### BACKGROUND ART

Today, more and more attention is paid to the freshwater resources. Fresh water is one of the essential elements for human existence and development. However, due to the accelerations of industrialization, population growth, and water pollution, freshwater scarcity is getting worse. Today many countries are faced with fresh water resource crises.

In the recent years, desalination technologies have been developed to supplement the supplies of fresh water resources. The most noticeable desalination technologies include the osmosis method and the membrane distillation method. The reverse osmosis method of desalination requires high operating pressures which entail high costs in mechanical components. In the reverse osmosis desalination, a membrane distillation (hereinafter referred to as “MD”) involves a new type of membrane separation technique. MD is a combination of thermally driven process and distillation membrane technology. MD apparatus can efficiently run at favorable conditions: at atmospheric pressure, lower evaporation temperatures, a lower operating pressure, a higher membrane distillation desalination rate, and a lesser membrane fouling than the reverse osmosis water flux apparatus.

MD is a hydrophobic microporous membrane operated on the principle that when the vapor pressure difference across the membrane exists, it becomes the driving force of mass transfer across the membrane. As such the separation process occurs. Since the MD can operate at a low temperature and pressure, solar energy, geothermal, waste heat of factories, and other low-grade heat source can be used. Therefore, MD renders the desalination easy to operate, etc., gaining competitive edge in many desalination projects.

Membrane distillation methods are classified into four different categories according to the technologies: (1) in direct contact membrane distillation (DCMD), the warm, vaporizing stream and the cold condensate stream (distillate stream) are in direct contact with the membrane to the filtrate side to generate a vapor pressure gradient serving as the, where both. (2) in air gap membrane distillation (AGMD), where the condenser surface is separated from the membrane by an air gap. (3) in sweeping gas membrane distillation, where the distillate is removed in vapor form by an inert gas; and (4) in vacuum membrane distillation, where the distillate is removed in vapor form by vacuum. This method is described only for the removal of volatile components from aqueous streams and the point at issue is not the production of a liquid distillate. Up to now direct contact membrane distillation with hollow tube form has attracted the most attention.

In the U.S. application Ser. No. 15/135,646, a submerged membrane module for use for desalination of water is disclosed. The membrane modules include one or more hollow membrane fibers that can be submerged either in a feed solution tank or the feed solution can pass through the lumen side of the membrane submerged within the tank. The feed solution can be a water-based feed stream containing an amount of salt. The system operates like cross-flow type, comprising: a feed in flow and feed out and distillate flow run continuously.

In the U.S. application Ser. No. 14/782,614 discloses a membrane distillation module and a wastewater treatment apparatus for purifying wastewater containing oil, salt, and organic matter produced when extracting petroleum from a stratum or a bedrock layer is disclosed. The membrane distillation module that used three different form hydrophobic porous membrane such as hollow fiber, tubular and bag-like composite. In which, the tubular membrane's shaped by sealing the two ends of the hydrophobic porous membrane. The apparatus required chemical-cleaning the oil that attached on the surface of the membrane after a period of time.

In the China patent No. CN102872721B, a marine multi-effect desalination membrane distillation apparatus comprising a raw water pump, filter, heat exchanger, reservoir, one or more hollow fiber membrane distillation tube module unit are disclosed.

However, the above listed methods require a hefty investment costs, difficult to maintain, and ineffective in desalination.

Therefore, what is needed is new submerged tubular direct contact membrane distillation technology that can reduce the membrane frame cost, which leads to a reduction in initial investment costs but effective in desalination.

What is needed is a new and simple submerged tubular direct contact membrane distillation comprising a supported tube frame, protective layers that provide gaps for water vapors to flow through the membrane, and an active layer for desalination.

Furthermore, what is needed is a submerged tubular direct contact membrane distillation that is easy to remove the salt (NaCl) components that are built up onto the surface of the membrane over time.

Furthermore, what is needed is a submerged tubular direct contact membrane distillation that is easy-to-maintain and replace when it is damaged and/or failed to operate due to wears and tears.

The submerged tubular direct contact membrane distillation and method of producing fresh water from salted water which includes seawater, brines, brackish water and the likes disclosed in the present invention solve the above described problems and objectives.

### SUMMARY OF THE INVENTION

Accordingly, an object of the present invention is to provide a desalination apparatus is disclosed which comprises: a first tank for storing seawater to be desalinated; a second tank comprising a hydrophobic membrane desalination module operable to absorb only fresh water vapors and reject salt components when the seawater is heated to a first predetermined temperature that changes the seawater into the fresh water vapors, and wherein the hydrophobic membrane desalination module is configured to continuously allow the distilled fresh water to make contact with the fresh water vapors within its interior hollow volume; and a third tank, in fluid communication with the second tank, configured to cause the fresh water vapors from the hydrophobic membrane desalination module to be condensed into liquid fresh water by continuously allowing the fresh water vapors to make contact with a coolant water at a second temperature.

Another object of the present invention is to provide a method for desalinating seawater using a hydrophobic desalination membrane, comprising the following steps: (a) heating seawater to a first predetermined temperature where seawater is changed into fresh water vapors; (b) absorbing only the fresh water vapors and rejecting the seawater by using a submerged membrane desalination module; (c) continuously condensing the fresh water vapors into distilled fresh water by allowing the fresh water vapors to catalytically contact with a coolant water at a second predetermined temperature lower than the first predetermined temperature; and (d) continuously allowing the fresh water vapors to catalytically contact with a the distilled fresh water liquid inside the hollow chamber of the hydrophobic membrane desalination module.

Another object of the present invention is to provide a desalination system and method that do not require high operating pressure and complex system.

Yet another object of the present invention is to provide a desalination system and method that are easy to maintenance and cost-effective to build.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 illustrates a desalination plant using a hydrophobic submerged tubular membrane distillation (STMD) in accordance with an exemplary embodiment of the present invention;

FIG. 2 illustrates the layers of the hydrophobic STMD in accordance with an exemplary embodiment of the present invention;

FIG. 3 presents a method of seawater desalination using a hydrophobic submerged tubular membrane distillation (STMD) in accordance with an exemplary embodiment of the present invention.

The figures depict various embodiments of the technology for the purposes of illustration only. A person of ordinary skill in the art will readily recognize from the following discussion that alternative embodiments of the structures and methods illustrated herein may be employed without departing from the principles of the technology described herein.

### DETAILED DESCRIPTION OF THE INVENTION

Reference will now be made in details to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in details so as not to unnecessarily obscure aspects of the present invention.

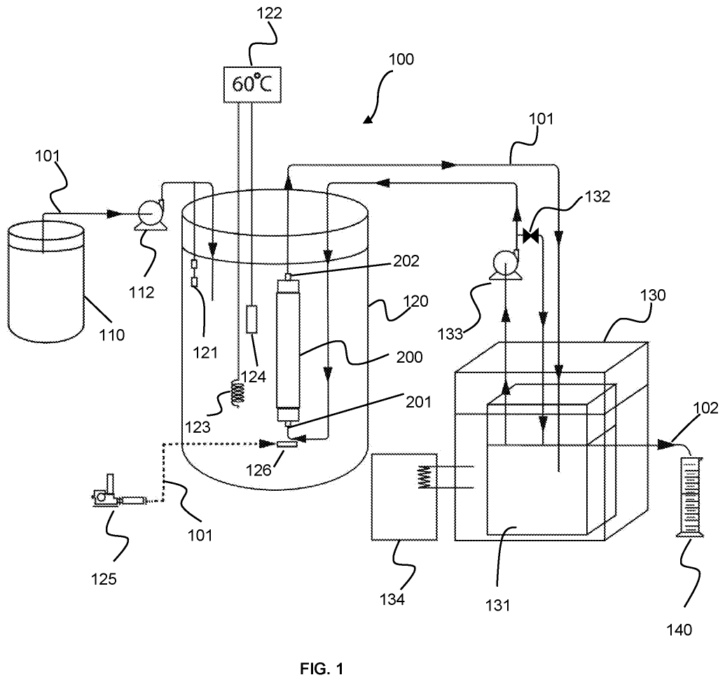

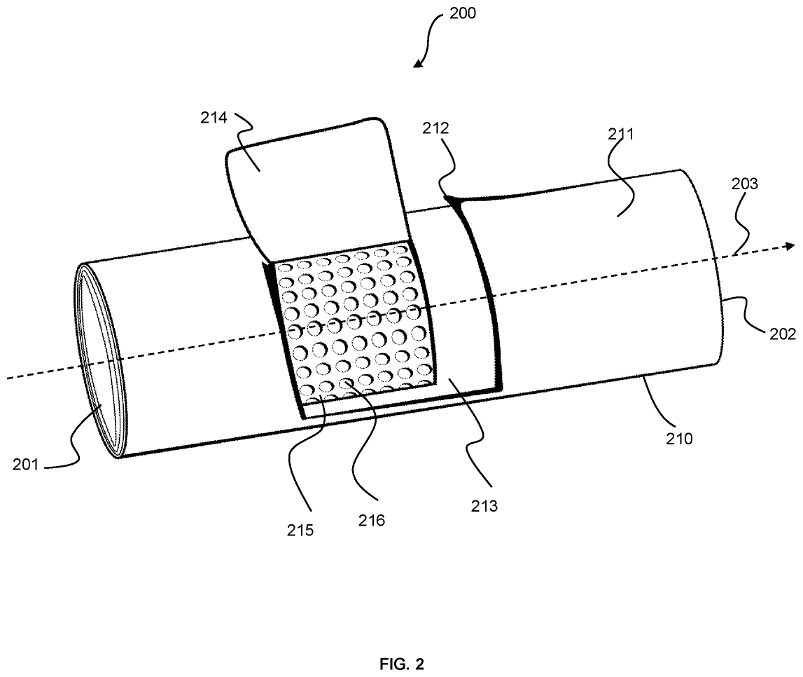

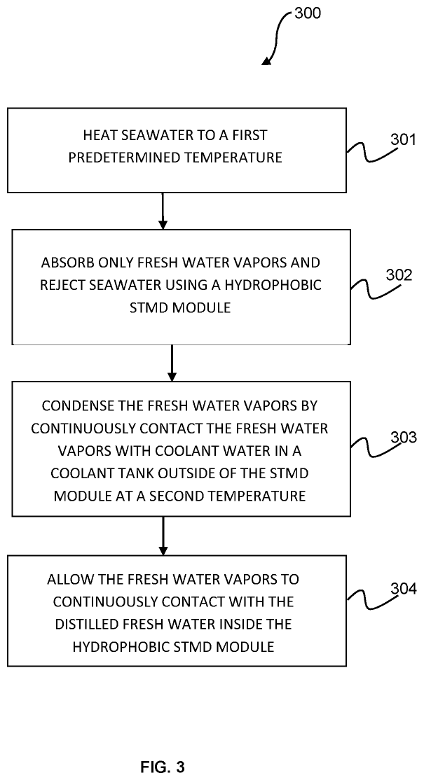

Exemplary embodiments and aspects of the present invention are now described with reference to FIGS. 1 to 3. The present disclosure discloses the following features of the present invention: (1) a simple and cost-effective desalination plant that is ecofriendly to marine environment; (2) highly pure and fresh water is achieved as the end result of the desalination plant of the present invention, (3) almost no carbon footprint, and (4) operating conditions are up to the evaporation temperature of water and at the atmospheric pressure. FIG. 1-FIG. 2 illustrate a mechanical construction of the desalination system using a submerged tubular membrane desalination (STMD) module in accordance to an exemplary embodiment of the present invention. FIG. 3 illustrates a desalination method that uses the submerged tubular membrane desalination (STMD) module.

Now referring to FIG. 1, FIG. 1 shows a desalination system 100 (“system 100”) using a hydrophobic submerged tubular membrane desalination (STMD) module completely submerged in a tank of seawater in accordance with an exemplary embodiment of the present invention. In various embodiments of the present invention, system 100 includes a feed tank (or a first tank) 101, a membrane tank (or a second tank) 120, a distillation tank (or a third tank) 130, a feed pump 112, a circulation pump 133, a hydrophobic submerged tubular membrane distillation module 200 (STMD module 200), a heating device 123, and a refrigerating unit 134. Feed tank 110, membrane tank 120, and distillation tank 130 are in fluid communication in controlled directions via fluid conductors 101 such as polyvinyl chloride (PVC) pipes, or any other well-known water conductors available in the markets. The seawater flow direction is controlled by feed pump 112 and circular pump 133. In various embodiments of the present invention, between feed tank 110 and membrane tank 120. In other embodiments of the present invention, system 100 further includes a stirrer (or blower) device 125, a temperature display unit 122, an electric floater unit 121, and a temperature sensor 124. Distillation tank 130 is further divided into an inner (distillation) tank 131 and an outer (coolant) tank 132. Distillation tank 131 has the same shape and is contained completely inside coolant tank 132. The area between distillation tank 131 and coolant tank 132 contains coolant water and connected to refrigerating unit 134. Circulation pump 133 has an input end and an output end. The input end is connected to draw distilled water from distillation tank 131. The output end is connected to pump distilled water from distillation tank 131 to hydrophobic submerged tubular membrane desalination (STMD) module 200. The output of hydrophobic STMD module 200 returns fresh water vapors to distillation tank 131. Feed pump 112 pumps seawater from feed tank 110 to membrane tank 120 via fluid conductors 101. Electric floater unit 121 is disposed inside membrane tank 120 and connected to fluid conductors 101. Electric floater unit 121 is designed to inform operators about the seawater level within membrane tank 120. Heating device 123, hydrophobic STMD module 200, and temperature sensor are disposed inside membrane tank 120. A water outlet 102 draws fresh water from distillation tank 131 to an output container 150 for use. In various embodiments of the present invention, heating device 123 is a heating coil. In other embodiments, heating device 123 may include apparatuses that generate heat energy from wind, solar, gas, waste to energy (WTE) engines, etc.

Referring next to FIG. 2, the structure of a hydrophobic submerged tubular membrane desalination (STMD) module 200 (STMD module 200) in accordance with an exemplary embodiment of the present invention is illustrated. Hydrophobic STMD module 200 is constructed by a central perforated tube 215, a first (inner) protective layer 214 is deposited on central perforated tube 215, a hydrophobic microporous membrane 213 is deposited on first (inner) protective layer 214, and a second (outer) protective layer 212 is deposited on hydrophobic microporous membrane 213. The outer circumference of central perforated tube 215 is perforated with holes 216. Each hole 216 has the diameter of 1 mm to achieve a high porosity and sufficient space for vapors to pass through hydrophobic microporous membrane 213. In various embodiments of the present invention, hydrophobic microporous membrane 213 is a polytetrafluorethylene (PTFE) membrane. In other embodiments, hydrophobic microporous membrane 213 may include other desalination membrane that can absorb fresh water vapors and reject salts (NaCl). The density of holes 216 in this layer is 25 holes per cm². The thickness of hydrophobic microporous membrane 213 is from 0.18 to 0.55 mm to achieve high permeate flux and membrane strength. If the thickness of this active layer is thinner, the permeate flux will be improved, but the membrane strength is weak. The pore size of hydrophobic microporous membrane 213 is from 0.1 to 1.0 micron. If the pore size of this active layer is smaller than 0.1 micron, the permeate flux rate is lower because there is not sufficient space for fresh water vapors to pass through hydrophobic microporous membrane 213. If the pore size is large, the wetting (salt passing) hydrophobic microporous membrane 214 is maximized, the hydrophobicity and the seawater treatment performance suffer, and hydrophobic microporous membrane 213 is easy to physical damage.

Referring now to FIG. 1 and FIG. 2, In system 100, hydrophobic STMD module 200, completely submerged inside membrane tank 120, is in direct contact with the coolant water from distillation tank 131 at its permeate side (interior side). While the exterior side hydrophobic STMD module 200 was surrounded by feed water raised at the first predetermined temperature. Hydrophobic STMD module 200 is based on the filtration of feed water through hydrophobic membrane 213 that only let (water) vapor to pass through. Other compounds which were non-volatile ones or required a high volatile temperature cannot penetrate the membrane. The driving force of the mass flux of system 100 was the water pressure difference across hydrophobic STMD module 200 which is mainly influenced by the variation of temperature between hot (membrane) tank 120 and the cold distillation (permeate) tank 130.

In operations, seawater is first treated to remove waste particulates and impurities. The clean seawater is stored in feed tank 110. After that, the seawater is pumped to membrane tank 120 by feed pump 112 via water conductors 101. The seawater level inside membrane tank 120 is observed by electric floating device 121. If the water surpasses a certain height, electric floating device 121 causes feed pump to stop pumping, preventing the heated seawater from spilling over membrane tank 120. This, as a result, saves heating energy and seawater. Ideally, the seawater level is maintained at a constant level by electric floating device 121 and feed pump 112. The clean seawater inside membrane tank 120 is heated up by heating device 123 to a first predetermined temperature where seawater is changed into fresh water vapors, salts, and other components. In many aspects of the present invention, the first predetermined temperature is set between 60° C. to 90° C. The first predetermined temperature is observed and maintained by heating device 122 and temperature sensor 124. Electric blowing device (stirrer) 125 is used to create a uniform temperature distribution within membrane tank 120. When the first predetermined temperature reaches the boiling temperature, the seawater in membrane tank 120 starts to vaporize, breaking the valence bonds between water molecules and salts (NaCl). Hydrophobic STMD module 200 absorbs the fresh water vapors and rejects salt and other components. This is caused by the pressure and temperature gradients between the heated seawater surrounding and the cold distilled water inside hydrophobic STMD module 200. The cold distilled water is set at second predetermined temperature set by refrigerating unit 134. In different aspects of the present invention, the second predetermined temperature is set at 28° C. When hot fresh water vapors contact the coolant water, the fresh water vapors condense to yield pure fresh water in form of liquid. This process is continued by circular pump 134 until the seawater inside membrane tank 120 is used up. The fresh water accrues more and more inside distillation tank 130. As the fresh water inside distillation tank 130 rises, outlet 102 pours fresh water to output tank 150.

Referring finally to FIG. 3, a method 300 for desalination using a hydrophobic submerged tubular membrane desalination (STMD) module is illustrated.

At step 301, seawater is heated to a first predetermined temperature. In many aspects of the present invention, first predetermined temperature is set between 60° C.-90° C. Step 301 is implemented by feed tank 110, feed pump 112, heating device 124, and membrane tank 130. The seawater is first removed of sewage particulates and impurities and stored in feed tank 110. Cleaned seawater free from impurities is fed pump to membrane tank 120 by feed pump 112. There, inside membrane tank 120, the seawater is heated up to the first predetermined temperature at about 60° C. to 90° C. At the first predetermined temperature, the seawater begins to change into fresh water vapors and salt components. This is because as the temperature rises, the valance bonds between water and salts are broken. Water molecules gain thermal energy and escape the valence bonds between water and salt molecules.

At step 302, fresh water vapors are absorbed using a hydrophobic membrane while salt components (NaCl) and residuals are rejected. Step 302 is implemented by hydrophobic STMD module 200. Hydrophobic STMD module 200, completely submerged inside membrane tank 120, is in direct contact with the coolant water from distillation tank 131 at its permeate side (interior side). While the exterior side hydrophobic STMD module 200 was surrounded by feed water raised at the first predetermined temperature. Hydrophobic STMD module 200 is based on the filtration of feed water through hydrophobic membrane 213 that only let (water) vapor to pass through. Other compounds which were non-volatile ones or required a high volatile temperature cannot penetrate the membrane. The driving force of the mass flux of system 100 was the water pressure difference across hydrophobic STMD module 200 which is mainly influenced by the variation of temperature between hot (membrane) tank 120 and the cold distillation (permeate) tank 130.

At step 303, fresh water vapors are condensed by continuously contacting fresh water vapors to coolant stream of water at a coolant tank set at a second predetermined temperature. In many aspects of the present invention, first predetermined temperature is set between 26° C.-29° C. Step 303 is implemented by coolant tank 130, circular pump 133, refrigerating unit 134, and distillation tank 131. The seawater is first removed of sewage particulates and impurities and stored in feed tank 110. Fresh water vapors are continuously pumped into distillation tank 131. There, the fresh water vapors are continuously contacted with cold water set at the second predetermined temperature by refrigerating unit 134. As a result, fresh water vapors condense into distilled fresh water.

At step 304, fresh water vapors inside a hydrophobic submerged tubular desalination (STMD) membrane is continuously allowed to contact with cold distilled water from a coolant tank. Generally, step 304 is implemented by system 100. More particularly, step 304 is implemented by hydrophobic STMD module 200 completely submerged inside membrane tank 120, circular pump 134.

In summary, the clean seawater is pumped into membrane tank 120. The clean seawater is heated by heating device 123 to form fresh water vapors. Once the water vapor is passed through hydrophobic membrane 213, it is condensed in coolant tank 131 before being recycled back to membrane tank 120 in hollow chamber 211 to attract the fresh water vapors into distillation tank 311, forming a cycle. Cool water in the present invention is distilled water and is continuously circulated to condense the water vapor.

System 100 and method 300 reduce the input pump costs. In addition, a simple tubular membrane design such as hydrophobic STMD membrane 200 described in FIG. 2 reduces the membrane frame costs, leading to a reduction in initial investment costs but still having a highly-effective desalination as compared to other proccesses.

### Testing Results

System 100 as described above was set up. Operating conditions: Feed temperature of 60° C., Cool stream temperature of 28° C. and initial feed seawater (TDS of 30,000 mg/L) and the feed concentration could gradually increase to very high TDS of o 80,000 mg/L until the end of filtration).

It was observed that, with the TDS concentration of feed water of 30,000-80,000 mg/L, the average removal efficiency of salinity, TDS, chloride and sulfate were 100%, 99.36%, 99.91% and 98.74%, respectively. The feed and cool temperature of 60° C. and 28° C. with a 0.45 μm pore size membrane, the flux reached 1.3 L/m²h. In addition, the removal of total organic carbon (TOC) stably achieved 96-99% for the feed with average TOC of 11.3 mg/L. The distilled (permeate) water complied with the standard limits of Vietnam national technical regulation on drinking water quality.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### DESCRIPTION OF NUMERALS

100 desalination plant using the hydrophobic STMD module

101 fluid connectors

102 distilled water outlet

110 first tank or feed tank containing seawater

112 feed pump

120 second tank or membrane tank

121 electric water level checker unit

122 first predetermined temperature display

123 heating device

124 temperature sensor

130 outer third tank or coolant tank

131 inner third tank or distillation tank

132 valve

133 circulation pump

134 refrigerating unit

200 hydrophobic STMD module

201 input end

202 output end

203 feed water flow direction

210 exterior side

211 interior side (permeate side)

212 outer (first) protective layer

213 active layer or hydrophobic membrane e.g. PTFE

214 inner (second) protective layer

215 perforated tube

216 holes of perforated tube

What is claimed is:

1. A desalination apparatus, comprising:
a first tank for storing seawater to be desalinated;
a second tank, configured to receive said seawater from said first tank, comprising a hydrophobic membrane desalination module operable to absorb only fresh water vapors and reject salt components when said seawater is heated to a first predetermined temperature where said seawater is changed into said fresh water vapors, and wherein said hydrophobic membrane desalination module is configured to continuously allow said distilled fresh water to make contact with said fresh water vapors within said hydrophobic membrane desalination module; and
a third tank, in fluid communication with said second tank, configured to cause said fresh water vapors from said hydrophobic membrane desalination module to be condensed into liquid fresh water by continuously allowing said fresh water vapors to make contact with a coolant water at a second temperature lower than said first predetermined temperature.

2. The apparatus of claim 1 wherein said hydrophobic membrane desalination module further comprises:
an input end for receiving said distilled fresh water from said third tank;
an output end for outputting said fresh water vapors to said third tank; and
a hollow chamber, located between said input end and said output end, configured to continuously allow said distilled fresh water to make contact with said fresh water vapors.

3. The apparatus of claim 1 wherein said hydrophobic membrane desalination module further comprises:
a perforated tube, covering said hollow chamber, operable to allow said fresh water vapors to pass through into said hollow chamber;
a first protective layer deposited on top of said perforated all;
a hydrophobic membrane, deposited on said first protective layer, operable to absorb only fresh water vapors and reject said liquid seawater; and
a second protective layer deposited on said hydrophobic membrane;

4. The apparatus of claim 1 further comprises:
a feed pump configured to pump said seawater from said first tank into said second tank;
a heater, deposited inside said second tank, configured to heat up said seawater in said second tank to said predetermined temperature;
a temperature sensor, deposited inside said second tank, configured to sense temperature inside said second tank;
a circulation pump configured to circulate said fresh water vapors from said hydrophobic membrane desalination module and pump said coolant water into said hollow chamber of said hydrophobic membrane desalination module.

5. The apparatus of claim 1 wherein said third tank further comprises:
a coolant tank containing said coolant water; and
a distillation tank, having a smaller volume than and completely located inside said coolant tank, configured to contain said distilled fresh water.

6. The apparatus of claim 5 wherein said coolant tank further comprises a refrigerating means for maintaining said coolant water at said second predetermined temperature.

7. The apparatus of claim 1 wherein said perforated wall further comprises a plurality of holes, each hole having a diameter of 1 mm.

8. The apparatus of claim 1, wherein the thickness of said first protective layer is 0.2 mm.

9. The apparatus of claim 1 wherein said hydrophobic membrane is made from a Polytetrafluoroethylene material having a thickness of 0.18-0.55 mm, and a membrane pore size of 0.1-1 micron.

10. The apparatus of claim 1 wherein said second predetermine temperature is from 26° C. to 29° C.

11. The apparatus of claim 1 wherein said first predetermined water is from 60° C. to 90° C.

12. A method for desalinating seawater into freshwater, comprising:
(a) heating seawater to a first predetermined temperature where said seawater is changed into fresh water vapors;
(b) absorbing only said fresh water vapors and rejecting said seawater by using a submerged membrane desalination module;
(c) continuously condensing said fresh water vapors into distilled fresh water by allowing said fresh water vapors to catalytically contact with a coolant water at a second predetermined temperature lower than said first predetermined temperature; and
(d) continuously allowing said fresh water vapors to catalytically contact with a said distilled fresh water inside a hollow chamber of said hydrophobic membrane desalination module.

13. The method of claim 12 further comprising the step of:
(e) submerging said hydrophobic membrane desalination module into a storage tank where said seawater is heated to said first predetermined temperature; and
(f) sensing and maintain said first predetermine temperature and said second predetermined temperature.

14. The method of claim 12 wherein said hydrophobic membrane desalination module further comprises:
an input end for receiving said distilled fresh water from said third tank;
an output end for outputting said fresh water vapors to said third tank; and
a hollow chamber, located between said input end and said output end, configured to continuously allow said distilled fresh water to make contact with said fresh water vapors.

15. The method of claim 11 wherein said hydrophobic membrane desalination module further comprises:
a perforated wall, covering said hollow chamber, operable to allow said fresh water vapors to pass through into said hollow chamber;
a first protective layer deposited on top of said perforated all;
a hydrophobic membrane, deposited on said support layer, operable to absorb only fresh water vapors and reject said liquid seawater; and
a second protective sheet deposited on said hydrophobic membrane.

16. The method of claim 13 wherein said perforated wall further comprises a plurality of holes, each hole having a diameter of 1mm.

17. The method of claim 13, wherein the thickness of said first protective layer is 0.2 mm.

18. The method of claim 13 wherein said hydrophobic membrane is made from a Polytetrafluoroethylene material having a thickness of 0.18-0.55 mm, and a membrane pore size of 0.1-1 micron.

19. The method of claim 13 wherein said second predetermine temperature is from 26° C. to 29° C.

20. The method of claim 13 wherein said first predetermined water is from 60° C. to 90° C.
